(19) United States
(12) Patent Application Publication
(10) Pub. No.: US 2014/0216268 A1
(43) Pub. Date: Aug. 7, 2014

(54) APPARATUS FOR COOKING AND SMOKING FOOD

(71) Applicant: Alfinity USA, LLC, Buda, TX (US)

(72) Inventor: Joe Burch, Round Rock, TX (US)

(73) Assignee: Alfinity USA, LLC, Buda, TX (US)

(21) Appl. No.: 13/963,098

(22) Filed: Aug. 9, 2013

Related U.S. Application Data
(63) Continuation-in-part of application No. 13/790,293, filed on Mar. 8, 2013.
(60) Provisional application No. 61/761,028, filed on Feb. 5, 2013.

(51) Int. Cl. A23B 4/052

(52) U.S. Cl. CPC A23B 4/0523
USPC 99/352

(57) ABSTRACT

A food cooking apparatus is disclosed. The food cooking apparatus comprises a smoker with a smoker cabinet and an oven with an oven cabinet. The oven typically overlies the smoker. Both the smoker and oven have separate independently controlled heating elements. The walls of the cabinets of the smoker and the oven are adapted such that almost all or no gas passes from the underlying smoker to the overlying oven. This is achieved by having a solid wall between the interior of the oven separating it from the interior of the smoker.

This is a continuation-in-part application of U.S. patent application Ser. No. 13,790,293, filed Mar. 8, 2013, that claims priority from U.S. Provisional Patent Application Ser. No. 61/761,028, filed Feb. 5, 2013, and is incorporated by reference herein.

### FIELD OF THE INVENTION

Food cooking assemblies, more specifically, a food cooking assembly having a vertical smoker on the bottom thereof and an oven on the top of the vertical smoker, both oven and smoker having separate heating elements and being gaseously sealed one from the other.

### BACKGROUND

Food cooking assemblies may be provided for grilling, smoking, frying or otherwise preparing food using heat sources. Those heat sources may be gas, electric or wood.

Occasionally, cooking assemblies will provide structure for achieving both smoking and cooking. However, these typically do not separate the smoking and cooking or oven functions and provide for a single, typically wood-fired heat source.

### SUMMARY OF THE INVENTION

A food cooking apparatus is disclosed. The food cooking apparatus comprises a smoker with a smoker cabinet and an oven with an oven cabinet. The oven typically overlies the smoker. Both the smoker and oven have separate independently controlled heating elements. The walls of the cabinets of the smoker and the oven are adapted such that almost all or no gas passes from the underlying smoker to the overlying oven. This is achieved by having a solid wall between the interior of the oven separating it from the interior of the smoker.

A food cooking apparatus comprising a smoker, the smoker having a smoker cabinet having sidewalls, a closed top wall and a bottom wall. The cabinet walls define a cabinet interior, and a door moveable between an open position and closed position provides access to the cabinet interior. A smoker control panel engages the smoker cabinet, the control panel having a control valve engaged therewith. A smoker heating element comprises either an electrical element or a gas element. The heating element is disposed in the cabinet interior above the bottom wall thereof and engages the control valve. A woodchip container may be provided. At least one cooking grid assembly is provided in the smoker cabinet interior. A cabinet smoker damper assembly engages the smoker cabinet so as to provide gaseous communication between the interior of the smoker cabinet and an exterior thereof. An oven includes an oven cabinet, the oven cabinet having side walls and a cabinet floor, and a top wall. The oven door is moveable between an open and a closed position, the open position allowing access to the cabinet interior, the closed position preventing such access, the oven cabinet is typically located above the smoker cabinet and is in gas sealing relation with the smoker cabinet such that gas in the interior of the smoker and gas in the interior of the oven do not communicate with one another. An oven control panel has a control valve engaged therewith. The oven includes an oven heating element, the oven heating element comprising either a gas or an electrical element, the overheating element disposed in the oven cabinet interior, the oven heating element engages the control valve of the oven control panel. A grid or a rack is disposed within the oven cabinet. An oven damper assembly engages the oven cabinet so as to provide for the communication of gases between the interior of the cabinet and the exterior thereof. An energy source energizes the heating elements of the smoker and the oven. The cabinet smoke damper assembly is engaged with the side walls of the smoker cabinet. The smoker cabinet typically has a vertical dimension greater than the horizontal dimension thereof. The oven cabinet and the smoker cabinet typically each have thermometers engaged therewith, at least a portion of which are adapted to engage the interior of each cabinet. The length and width of the side walls of the oven cabinet, in one embodiment, are substantially the same as the length and width of the smoker cabinet.

### BRIEF DESCRIPTION OF THE DRAWINGS

FIGS. 1 and 2 are perspective views of the exterior of Applicant's food cooking apparatus.

FIG. 3 is a front perspective view of the interior of the smoker.

FIGS. 3A-3C are views of alternate embodiments of the smoker oven interior.

FIG. 4 is a detail view of the grid and rail assembly, which may be used without Applicant's food cooking apparatus or with any other food cooking apparatus.

FIGS. 4A and 4B are partial perspective views of separation walls that can be used to separate the oven cabinet from the smoking cabinet so as to effectively prevent gaseous communication between the two.

FIGS. 5A and 5B are perspective detail views of the grid assemblies that may be used with Applicant's cooking apparatus or with any other cooking apparatus that utilizes a slide-out grid.

FIG. 5 is perspective view of the interior of the smoker cabinet with the grid partially slid out.

FIGS. 6 and 7 are perspective views of Applicant's cooking and smoking apparatus with both the smoker and oven doors open.

FIGS. 8-10 are top, side elevation, and perspective views of an embodiment of Applicant's grid assembly.

FIG. 11 is a perspective external view of Applicant's food cooking apparatus.

FIG. 12 is a perspective view of the vertically adjusting grid system for use on the interior of the smoker cabinet of Applicant's food cooking apparatus.

FIG. 13 is a perspective detail view of the manner in which Applicant's adjustable slide rail engages the adjustment bars of the adjustable rail system.

FIGS. 14 and 15 are cross-sectional views of partially inserted and fully inserted slide rails of the embodiment illustrated in FIG. 13.

FIG. 16 illustrates a rack for use in the sliding grid assembly which carries a water pan for use in the smoker of Applicant's food cooking assembly.

### DETAILED DESCRIPTION OF PREFERRED EMBODIMENTS

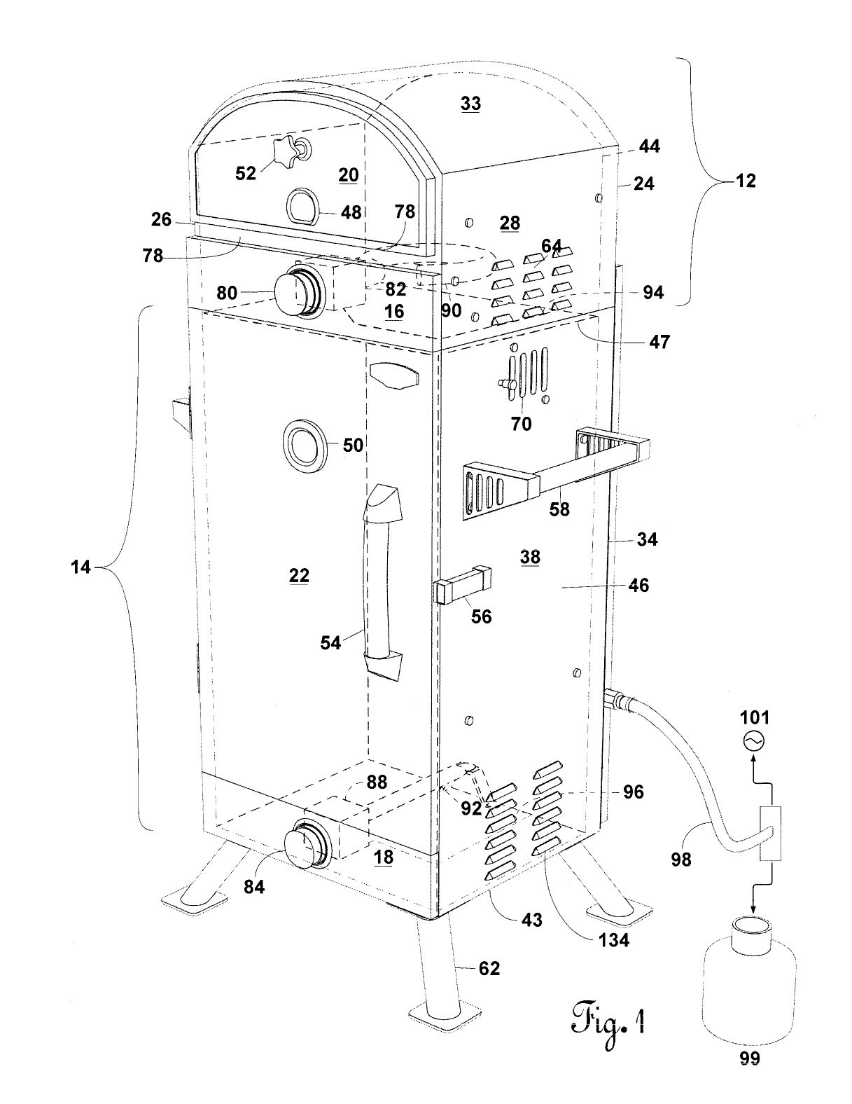

FIGS. 1-4 illustrate Applicant's food cooking apparatus 10. Food cooking apparatus 10 consists of an oven over a smoker, with both the oven and smoker having separate heat sources and sealed from one another, so that substantially no gases pass from the underlying vertical smoker to the overlying oven.

Food cooking apparatus 10 is seen to include an oven cabinet 12 overlying a smoker cabinet 14. An oven control panel 16 is provided for control of energy (typically gas or electric) to the heating element 90 of the oven. Smoker control panel 18 is provided, again for engaging heating elements 92 (may be gas or electric), which heating element is provided to heat smoker cabinet 14. Oven and smoker doors 20/22 are provided with hinges 78, hinged in ways known in the trade, to move between an opened and closed position. The opened position will allow access to smoker interior 46 when the smoker door is open and, when oven door is opened, will provide access to oven cabinet interior 44 of the oven.

Turning back to oven cabinet 12, it is seen to have side walls 24, which may be planar or substantially flat in a preferred embodiment. Side walls 24 may include front wall 26, right side wall 28, left side wall 30, and rear side wall 32. A top wall 33 may be provided, which may be planar or arced or configured in other ways. There is not much to the front wall, as it mostly defines an open space for the door.

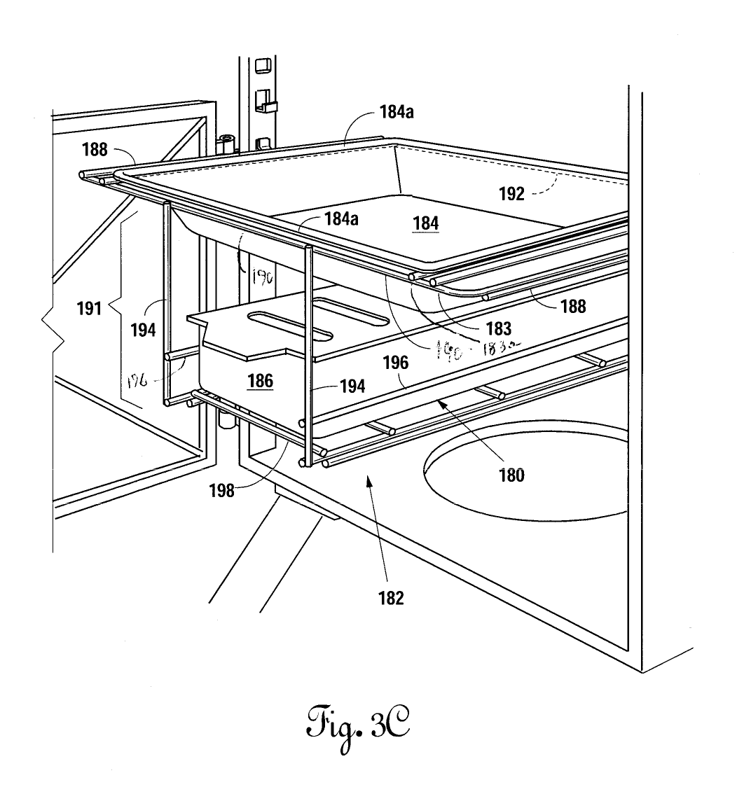

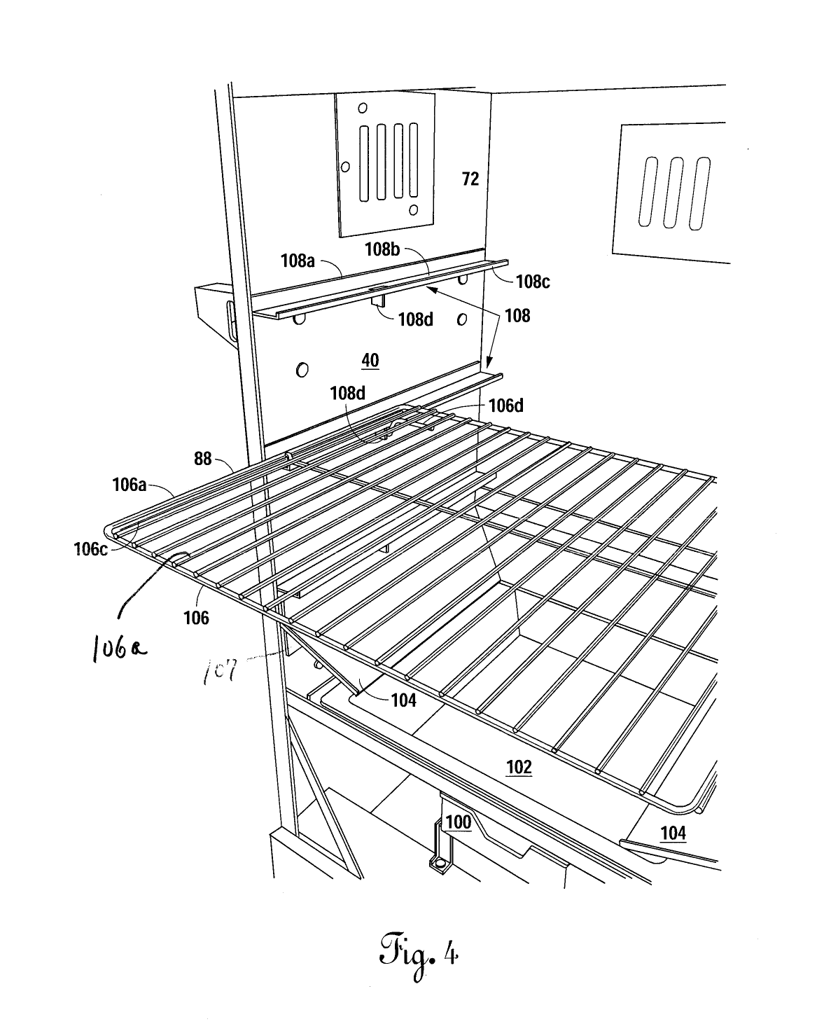

Smoker cabinet 14 may include side walls 34 which, in a preferred embodiment, may be planar and may be contiguous with the side walls 24 of the oven cabinet so they lay in the same plane. Side walls 34 of smoker cabinet 14 may include a front side wall 36 (again, mostly defining a door opening), right side wall 38, left side wall 40, and rear side wall 42. A bottom wall 43 may be provided. A separation wall 47, which may be a single sheet (see FIG. 4A), a double sheet (see FIG. 4B), or any other suitable member, typically joins the side walls of either or both of the cabinets, so as to seal the smoker interior 46 from the oven interior 44, so that gas does not pass between the two.

The side walls of the two cabinets are typically vented through damper assemblies. Oven damper assemblies 64/66/68 may be provided in the right, rear, and left side walls of the oven cabinet 12, or any other suitable locations, to vent the interior of the oven cabinet. Likewise, smoker damper assemblies 70/72/76 may be provided in the side walls or other suitable location of the smoker cabinet 14, so as to provide venting between the interior of the smoker cabinet and the exterior. The damper assemblies may be adjustable as known in the art.

Door hinges 78 are conventional and may be provided for articulating doors 20/22. Doors may include door handles 52/54 which, in one embodiment, are threaded on with fasteners which pass through the inside of the door to threaded mounting bosses or channels on the door handles. In this manner, they may be removed from the inside and leave the door surfaces flush or flat. The substantially flat door surfaces, along with the similar removable cabinet handles 58/60, will provide for ease of packaging, given that with the flat side walls, flat bottom wall, and removal of the handles, packaging in a substantially rectangular package is more easily achieved.

Thermometers 48/50 are typically mounted on doors 20/22 in ways known in the art to measure the temperature of the smoker and oven interior. Legs 62 may be mounted to a typically flat smoker bottom wall 43 by threading fasteners from the inside of the bottom wall through the bottom wall into mounting studs at the upper end of the legs 62. The purpose of the legs is to mount the food cooking apparatus above a support surface, such as a floor or deck.

Turning back to oven and smoker control panels 16/18, they are seen to include control knobs 80/84, which may be rotatably mounted to the exterior of the panel, control knobs typically include a shaft passing through the control panel and into control valves 82/86, which are known in the art. Heating elements 90/92 are provided typically within the interior of the smoker and oven cabinets, and are independently operated to control and provide access of energy to the interior of the smoker/oven. That is to say, heating elements 90/92, which engage internal energy engagement pipes 94/96 through control valves 82/86 are provided. An external energy engagement conduit 98 may be provided. When compressed gas 99 is used as a heat source, a flexible gas line is provided that attaches typically to the rear or any other suitable place on food cooking apparatus 10. It will typically tie into internal energy engagement pipes 94/96 (one to each heating element), which may be metal conduit, such as copper tubing or stainless steel, and which may include a T-junction where the end of energy engagement conduit, which may be flexible pipe meets internal energy engagement pipes 94/96. Note that the gas supply to burner element is independently controlled through separate control valves 82/86.

If electrical energy 101 is used, external conduit 98 may be an electrical cord and internal energy engagement pipes 94/96 may be solid pipe carrying conductors with proper insulation to control valves 82/86. In the case of electrical energy 101, the heating elements 90/92 may be electric as is known in the art. It is also in one embodiment, a mixture of gas and electric—either the top or the bottom being one of gas or electric, and the other of the top or bottom being the other of gas or electric. For either gas or electric, control knobs 80/84 and control valves 82/86 are known in the art, as are heating elements 90/92 for either gas or electric.

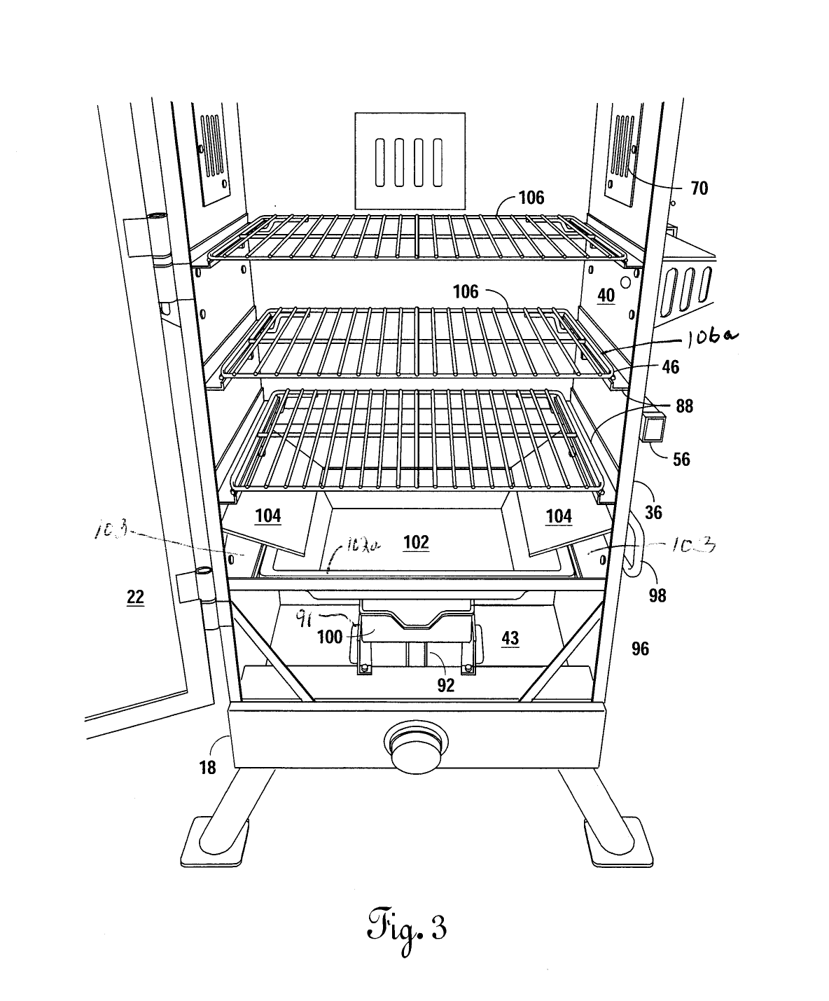

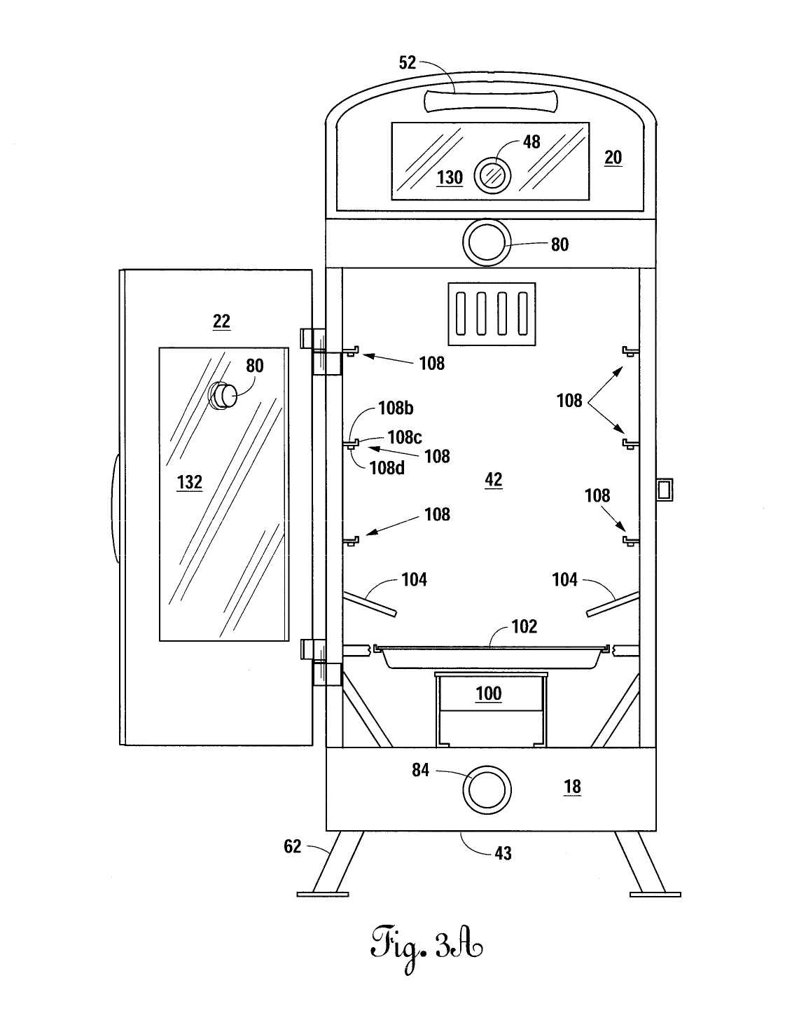

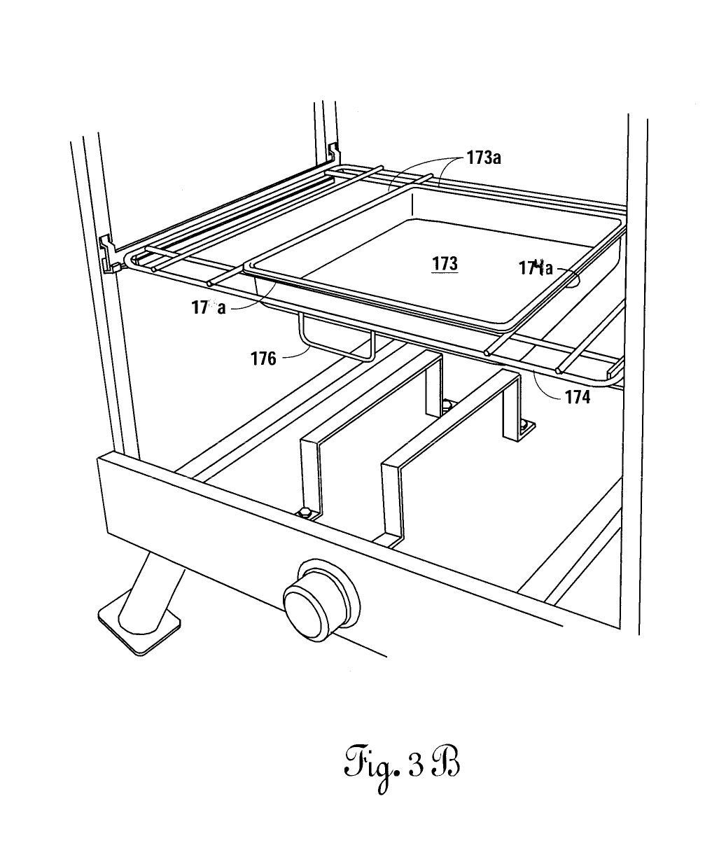

Turning now to FIGS. 3 and 3A, some of the details of the interior of smoker cabinet 14 may be seen. Smoker cabinet 14 may include a woodchip box 100 with walls configured to have an open top and to be able to receive woodchips therein. Support members in the cabinet interior, here extending from the bottom wall up to the woodchip box 100, maintain the woodchip box 100 over heating element 92. A water pan 102 is seen configured with an open top and capable of holding a fluid, such as water, therein. Again, rails, busses, legs or other support members may be provided engaging the interior walls of the smoker cabinet to maintain water pan 102 located typically above heating element 92. Drip rails 104 are seen engaging the side walls of the smoker cabinet interior and canted downward so as to direct fluids, such as fat or grease, into water pan 102.

Above the woodchip box 100 and water pan 102 are seen to be one or more grid assemblies 88. Grid assemblies 88 are seen to include grid members 106 engaging L shaped side rails 108 in a manner that allows the grid members to slide in a horizontal plane outwards when the door is opened.

In one configuration, grid assemblies 88 are configured in ways known in the art and simply slide back and forth in such a manner that they are capable of tilting when pulled out, for example, if there is a heavy dish near the front of the grid member 106 and the grid member is pulled out, the weight of a dish may cause it to pivot. However, in another embodiment, grid assemblies 88 may be non-tilting.

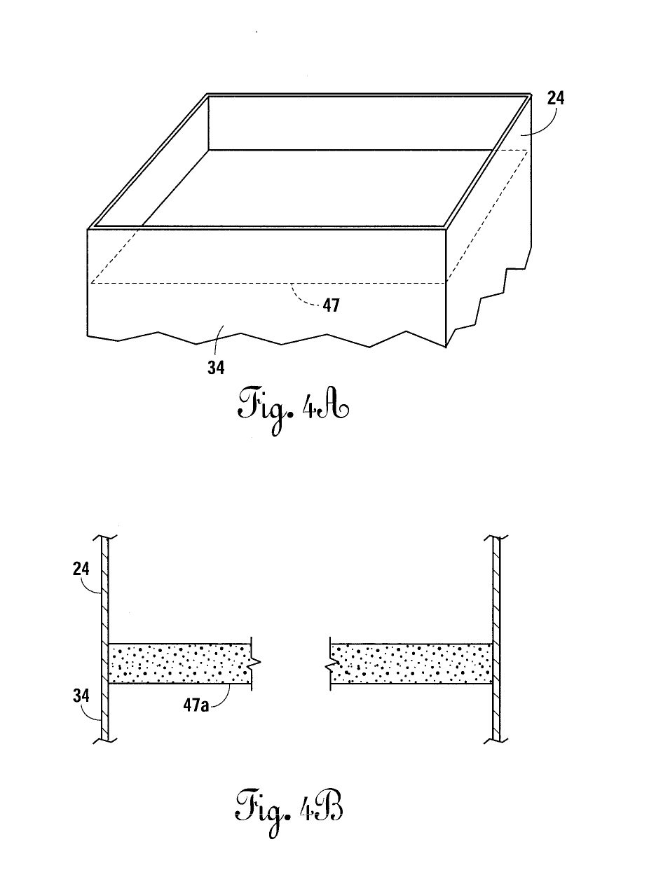

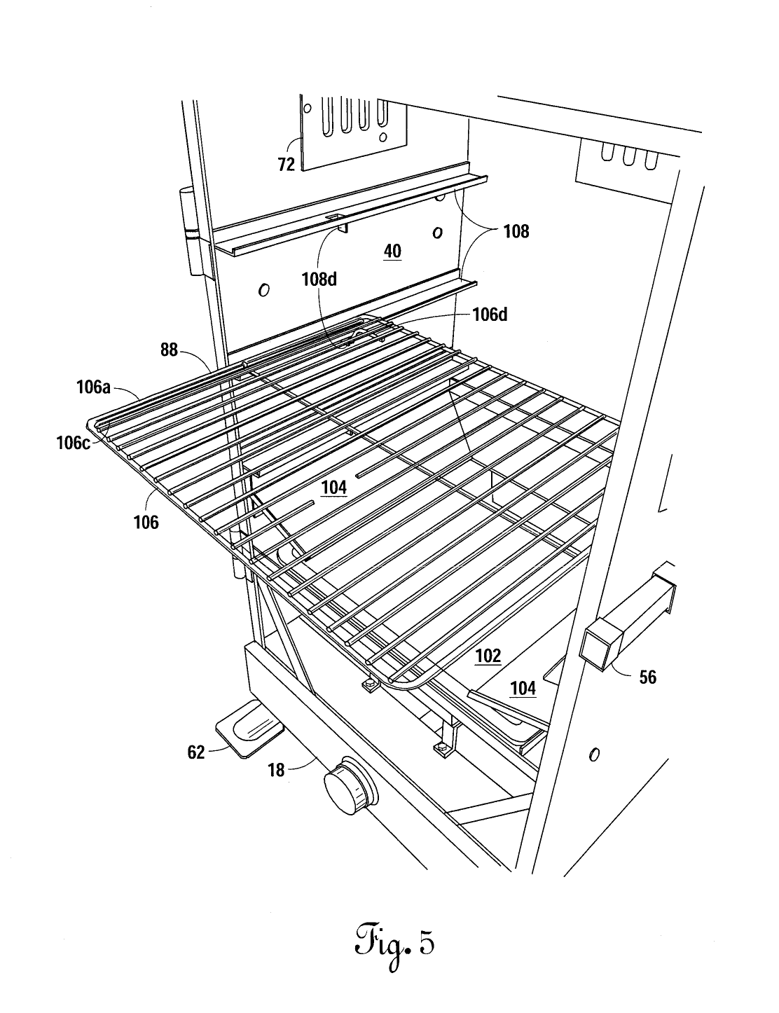

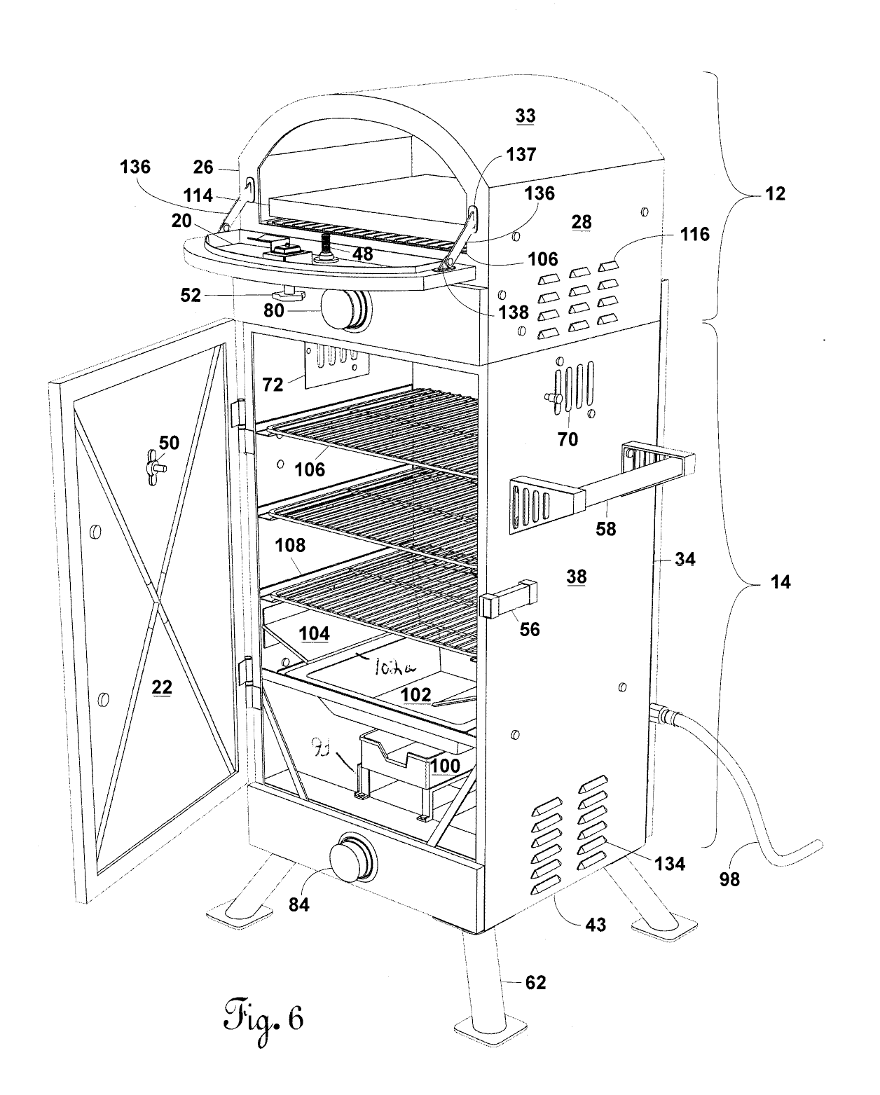

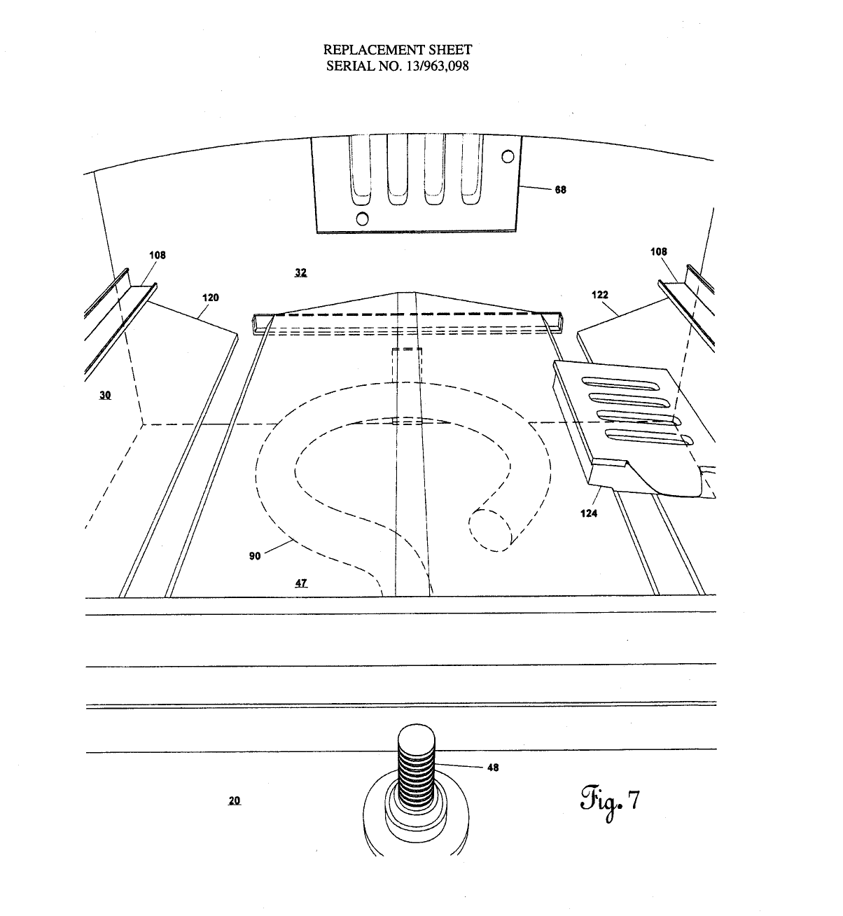

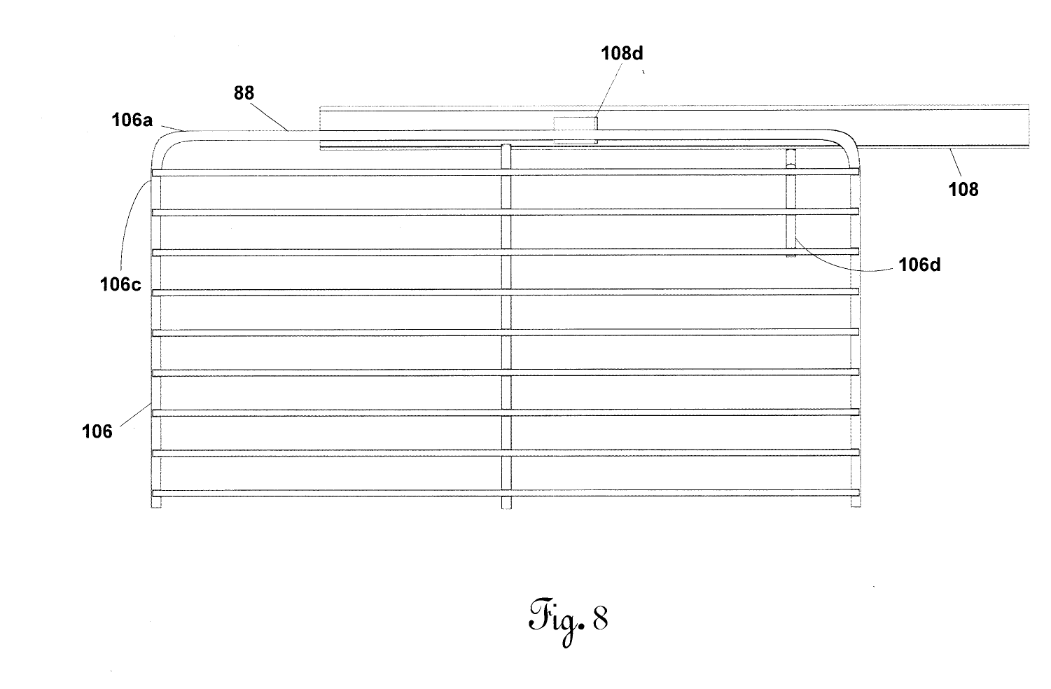

FIGS. 3, 4, 5A, 5B, and 8-10 illustrate a non-tilting grid assembly 88. In this configuration, grid member 106 is seen to include a pair of spaced apart grid side rails 106a. It is noted that in this configuration, L shaped slide rails 108 may include a vertical leg 108a, which typically joins the inner wall of the side walls of the smoker cabinet. Extending outward generally perpendicular from leg 108a is a foot 108b. At the removed end of foot 108b is a substantially vertically upturned lip 108c. A stop member 108d depends downward from the underside of foot 108b as seen in FIG. 4 to engage a configured member 106d located perpendicular to the transverse members of the grid member near the trailing edge as seen in FIGS. 4 and 5B. Configured member 106d is configured to engage the underside of foot 108b in a slideable manner so as to sandwich capture foot 108b between the upper surface of the removed end of configured member 106d and a lower member of lower rail 106c. Lower rail 106c is fastened as by welding or the like to the underside of side rail 106a. Moreover, the inner walls of lower rail 106c snugly engage the inner walls of lip 108c, so when the grid member slides in and out it will not get cocked sideways or jammed (See FIG. 5A). Thus, with non-tilting grid assemblies 88, there is contact between the underside of the side rails and the upper surface of 108b, as well as contact between the upper surface of the removed end of configured member 106d and the underside of foot 108b to prevent tilting of pivoting of a heavy object, such as a pan, is near the front of the grid member when it is pulled out. Moreover, snug contact fit between the inner walls of opposed lips 108c and the outer surfaces of lower rail 106c will prevent tilting.

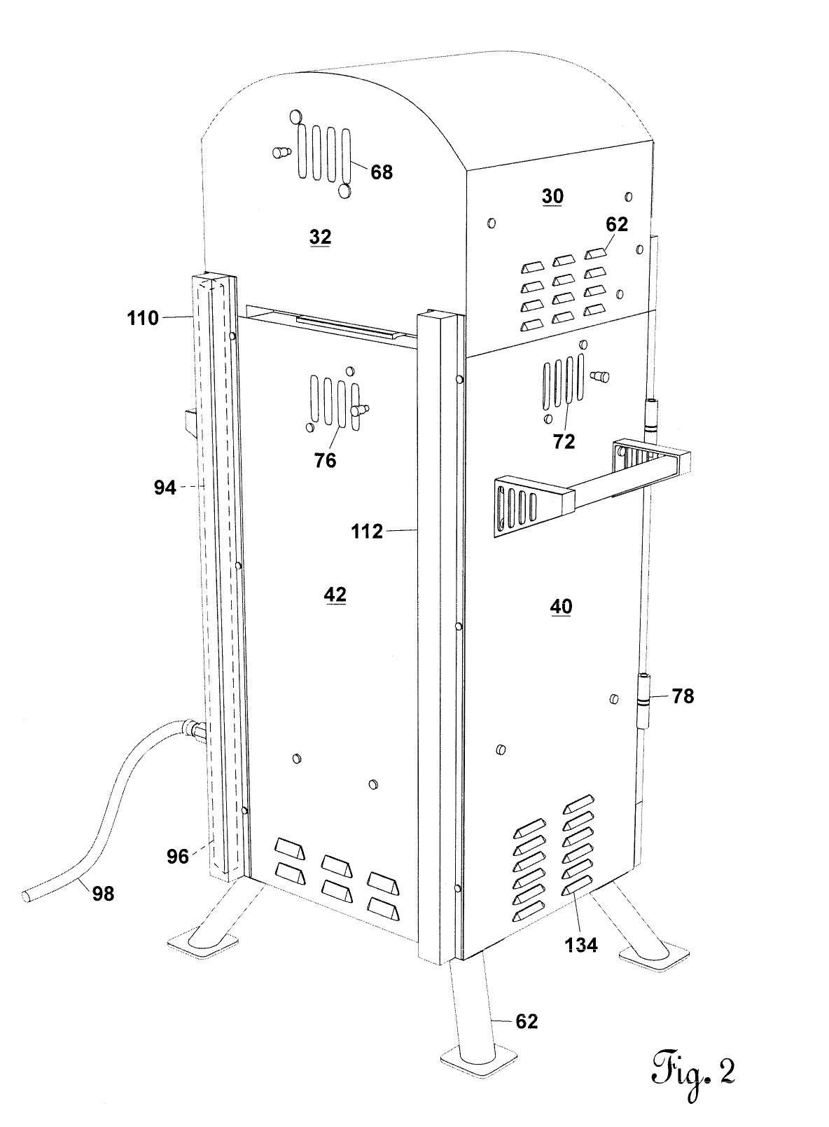

FIGS. 1-7 illustrate further details of Applicant's food cooking apparatus 10. In FIG. 2 it is seen that in a rear view at least partially engaging some of the rear walls are U-shaped channels 110/112 trending vertically on the left and right edges of the rear wall and intended to provide a flat surface for laying the device in a shipping container and also for protection of elements, including energy-engagement pipes 94/96 therein.

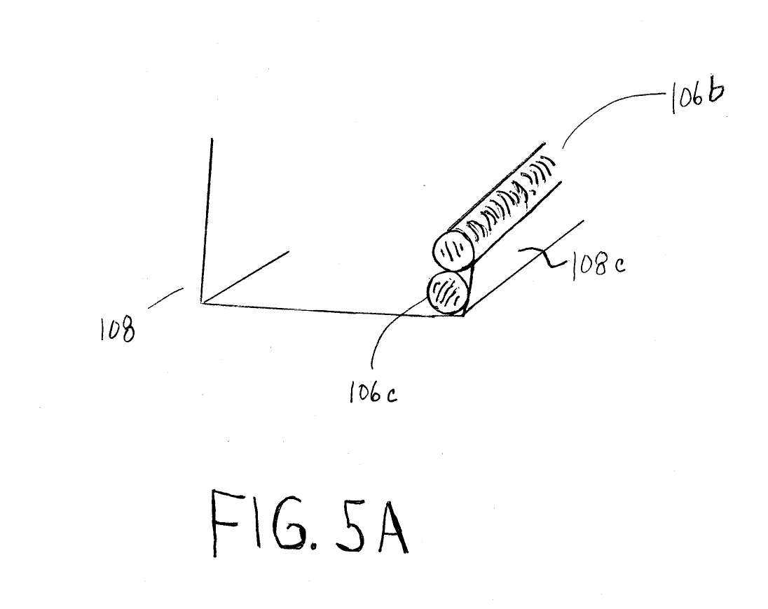

FIG. 6 illustrates a cooking stone 114 in one embodiment rectangular and dimensioned to fit within the door of the upper oven. Cooking stone 114 is adapted to simply lay on a grid member 106. It is also seen that louvers 116 may be seen for use in conjunction with a damper assembly. Louvers may be used or damper assemblies may be used without louvers at any of the locations on the smoker suitable for use.

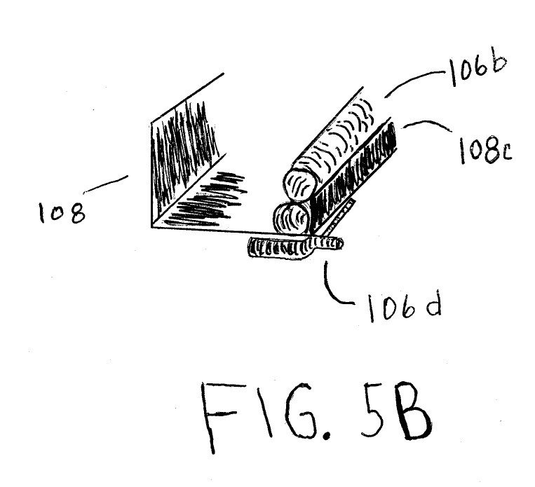

FIG. 7 illustrates the interior of the oven and shows the manner in which a diverting tent or plate 118 which may be shaped like an inverted V may be placed on brackets or other cabinet wall support to receive anything that may drip from food being cooked within the oven to protect the burner from such drippings. Moreover, it is seen that canted side rails 120/122 may be provided to divert drippings. Also, it is seen that a woodchip box 124 may be used for placement within the oven, for example, on the surface of the grid (not shown in FIG. 7 but shown in FIG. 6) or on the surface of the cooking stone 114.

Applicant's novel gas cooker provides a sizeable oven atop a spacious gas water smoker. The sturdy cabinet design may be made, in one embodiment, from 22 gauge steel or other suitable material. The smoker may have a capacity of about 2.24 cubic feet and may include, in one embodiment, three 18-inch by 16-inch slide out cooking grids, for a total of about 723 square inches. The woodchip box may be stainless steel and the steel water pan may be porcelain coated. The smoker may use a single high-grade (304) stainless steel burner rate at 13,000 BTUs.

The flip-down door provides access to the top-mounted gas oven for baking various foods and is perfect for pizza (it fits a large 14-inch diameter pizza). Smoke flavor may be added to the pizza or calzones by using the specially designed woodchip box 124 in the oven. The oven typically uses high grade (grade 304) stainless steel rated at about 10,000 BTUs. The finish on the housing of the smoker and oven may be black hammer-tone textured paint.

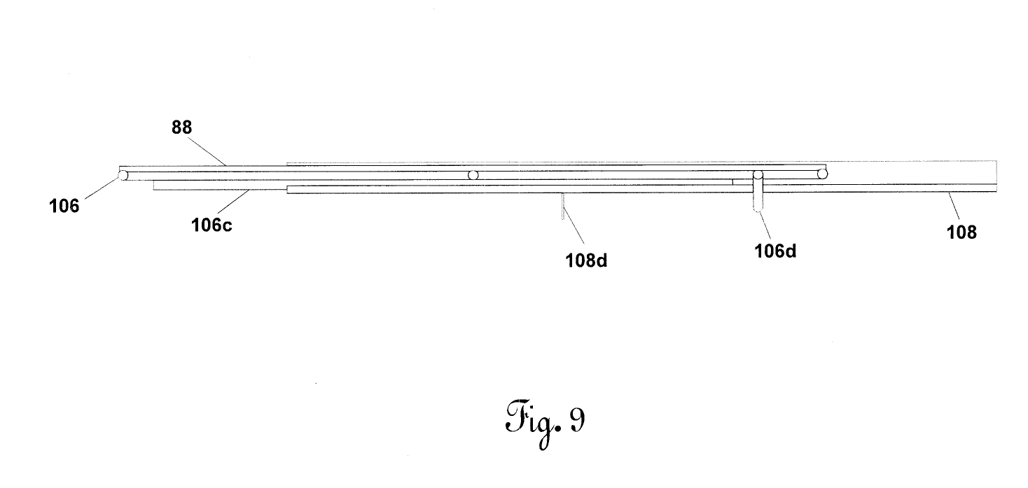

Turning to FIGS. 1 and 11, it is seen that the upper door 20 may be provided with a glass window 130 for providing viewing of the contents of the oven. A handle 52 may be provided, usually above the glass window, for easy drop down of the oven door on its hinges. A lower glass window 132 may also be provided in the smoker unit and side louvers 134 may be used to ventilate the smoker cabinet.

Turning back now to FIG. 6, it is seen that drop-down door 20 may be provided with diagonal brackets 136 which connect the door to portions of the front wall surrounding the door opening. Diagonal brackets or members 136 may slide through a slot 137 in the perimeter adjacent the oven opening when the door is closed and slide out of the slot when the door is open. A hinge or pivoting member 138 may be provided for the removed end of brackets 136 and a boss at the near end may provide an interference stop against the inner perimeter of the slot. The diagonal brackets are dimensioned to maintain the door in a perpendicular down position.

Turning now to FIGS. 3B and 3C, it will be seen that Applicants provide for a variety of structures arranged to removably receive a water pan and/or woodchip box 100 in the smoker cabinet 14. In FIG. 3, it is seen that woodchip box 100 may be adapted to be supported above heating element 92 by support members 91. These support members may be tied into any portion of the floor or inner cabinet walls so as to properly space the woodchip box 100 above burner or heating elements 92, in a manner in which the woodchip box 100 may be removed from the cabinet. In FIG. 3, this is seen by providing a lip along the upper perimeter of the box which engages the upper perimeter of the upwardly projecting support members 91. In FIG. 6, it is seen that support members 93 are simply configured to engage the underside of the fire box 100. In both cases, movement in the fire box is provided so that it may be slid out and reloaded with chips. In FIGS. 3 and 6, support of the fire box is provided from underneath by support elements extending upwards from housing interior members.

FIGS. 3 and 6 further illustrate that water pan 102 is configured with a lip 102a (in FIGS. 3 and 6). Lip 102a rests on lateral members 103, which lateral members may extend horizontally from the side wall, rear wall, or portions of the front lip of the front door as seen in FIGS. 3 and 6. The lateral members are designed to engage the lip such that the water pan 102 may be lifted out. It may be lifted out for cleaning or adding water thereto. Drip rails 104 may be set upon side wall members 107 (see FIG. 4).

It is seen that both the water pan and woodchip box are both supported independently on rigid engagement members, which rigid engagement members, in one embodiment, extend inward from the inner walls of the cabinet interior.

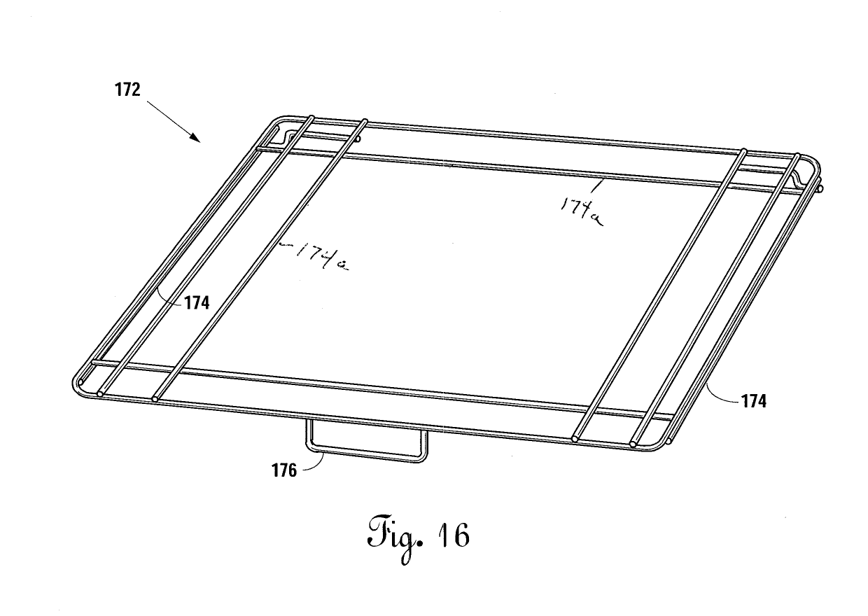

Turning to FIG. 3B, however, it may be seen that a water pan/sliding grid assembly 172 may be provided in which the water pan is suspended in members of a sliding grid or rack 174, which is in turn slidably engaged with any of the variations of the side-mounted grid supporting slide rails (non-adjustable or adjustable) as shown in these specifications. Thus, easy removal of the water pan is achieved by sliding out a sliding grid or rack 174. Such sliding grid or rack has all of the features of the other grids and rails, including the stop feature and the non-tip feature. It is seen with reference to FIG. 3B that a lip 173a around water pan 173 may be provided to engage perimeter members 174a of the grid (see FIG. 16). A handle 176 may be seen depending from a front cross member of sliding grid 174. Additional functionality is achieved with the use of Applicant's water pan/grid assembly in that pan clean out or addition of water may be achieved without removal of configured water pan 173, since the sliding grid 174 may be pulled out without tipping.

Turning to FIG. 3C, it is seen that yet another embodiment of a pull-out sliding grid/water pan assembly 180 is provided, however, one in which means are provided suspended from beneath the grid for maintaining a woodchip box as part of the sliding assembly such that pulling out the assembly causes it to slide out while carrying both the water pan and the woodchip box. Moreover, the water pan again may be removed, or not; and the woodchip box is provided with structure that allows it to slide out in turn from the means beneath the grid in which the woodchip box is supported.

It may be seen then with reference to FIG. 3C that a sliding water pan/fire box assembly 180 is provided. The assembly consists of a rack 182, a configured water pan 184, and woodchip box 186, all engaged such that they may slide out along the side slide rails set forth herein and having at least some of the features (stop and anti-tip) of the early embodiments. Rack 182 is seen to include an upper rack portion 183 that has side members 188 for engaging the side rails of the smoker cabinet. Upper rack 183 has pan engaging members 183a configured to suspend a water pan 184, for example, by engagement of water pan lip 184a with pan engaging members 183a. Engaged with and suspended below upper rack 183a is lower rack 191, with members configured to removably receive fire box 186 therein. In one embodiment, a multiplicity of legs 194 depend downward from some of the grid members of upper rack 183. Lower rack 191 may include these legs along with a multiplicity of side members 196 providing restraint of lateral movement and lateral support to woodchip box 186. Bottom support members 198 may be provided to engage and hold the weight of and support the fire box therein. The front of lower rack 191 may be open and unobstructed, in one embodiment, so as to allow the fire box to be easily removed from the sliding water pan/fire box assembly 180. Upper rack 183 may include a front cross member 190 and a rear cross member 192.

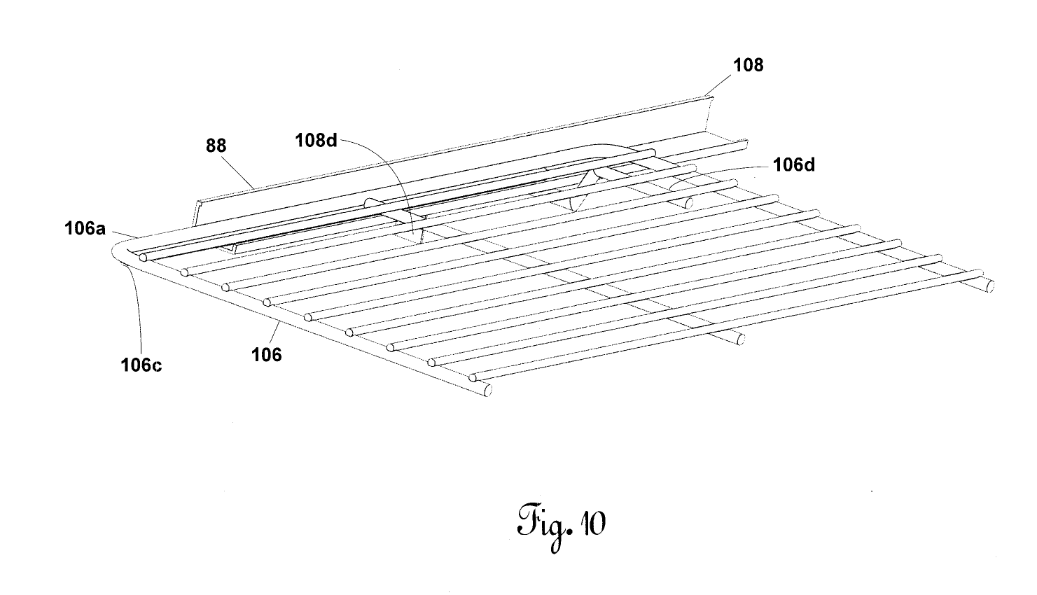

Turning to FIGS. 12, 13, and 14, it is seen that alternate embodiments of Applicant's L-shaped slide rails designated with element member 108 in early embodiments is provided. In earlier embodiments, for example, FIG. 3, it is seen that L-shaped slide rails 108 are fixed, as by welding or the like, to the inner side wails of the smoker cabinet 14. They cannot be moved vertically within the cabinet and, therefore, grid member 106 is fixed in the position of the slide rail pairs.

Turning, however, to FIGS. 12 through 14, it is seen that structure is provided for adjusting the vertical location of the slide rail pairs within the cabinet to any one of a pre-selected multiplicity of positions. This function is accomplished by using, in one embodiment, four vertical adjustment members or bars 140/142/144/146, configured to engage the inner side walls of the smoker cabinet and, in turn, configured to removably engage, at a number of possible positions (twelve shown in FIG. 12), left adjustable side rail and right adjustable side rail 152/154, that is, an adjustable slide rail pair 152/154. Slide rails 152/154 are configured to receive grid members 106 (or racks 174/183), which are configured the same as in earlier fixed rail embodiment. Left and right slide rails 152/154 are similarly configured to slide rails 108 in that they have stop engaging members and grids configured to prevent tip of the grid members 106. However, levt and right slide rails 152/154 have additionally, on either end thereof, structure configured to removably and toollessly cooperate with and engage structure on the adjustment bars so as to vertically locate the pairs at a pre-selected height within the cabinet.

In one embodiment, the adjuster bars are provided spaced near corners of an imaginary rectangle as seen in FIG. 12, therefore providing a front right 140, rear right 142, front left 146, and rear left 148 vertical adjuster bars trending longitudinally parallel with the vertical axis of the combination unit. Slide rails 152/154 may have gussets 155 therein to help prevent flexing of the L-shaped member, especially important as it may be seen that in the embodiment illustrated slide rails 152/154 are supported only at the removed ends thereof to the cabinet inner side walls. The adjuster bars 140/142/144/146 may be seen to have lower mounting flange 168 and upper mounting flange 170 that may provide for fastener attachment to the side wall or the adjuster bars may be engaged to side walls in any fashion known in the art.

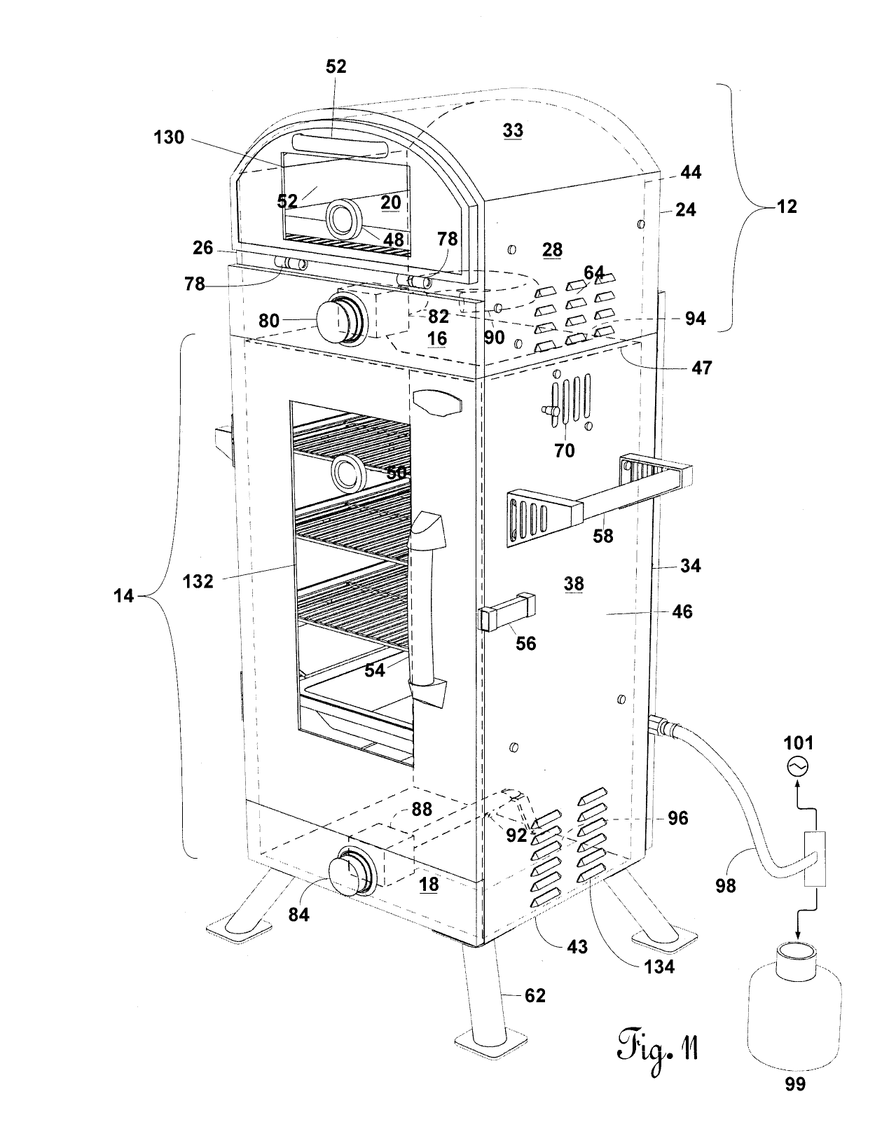

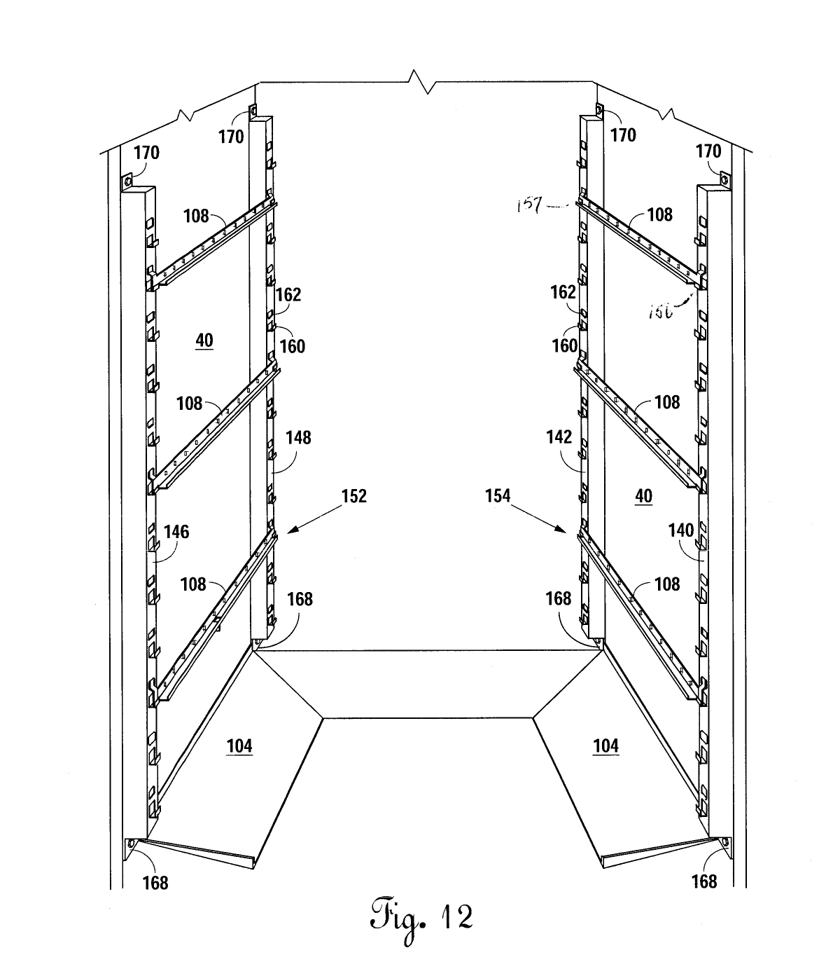

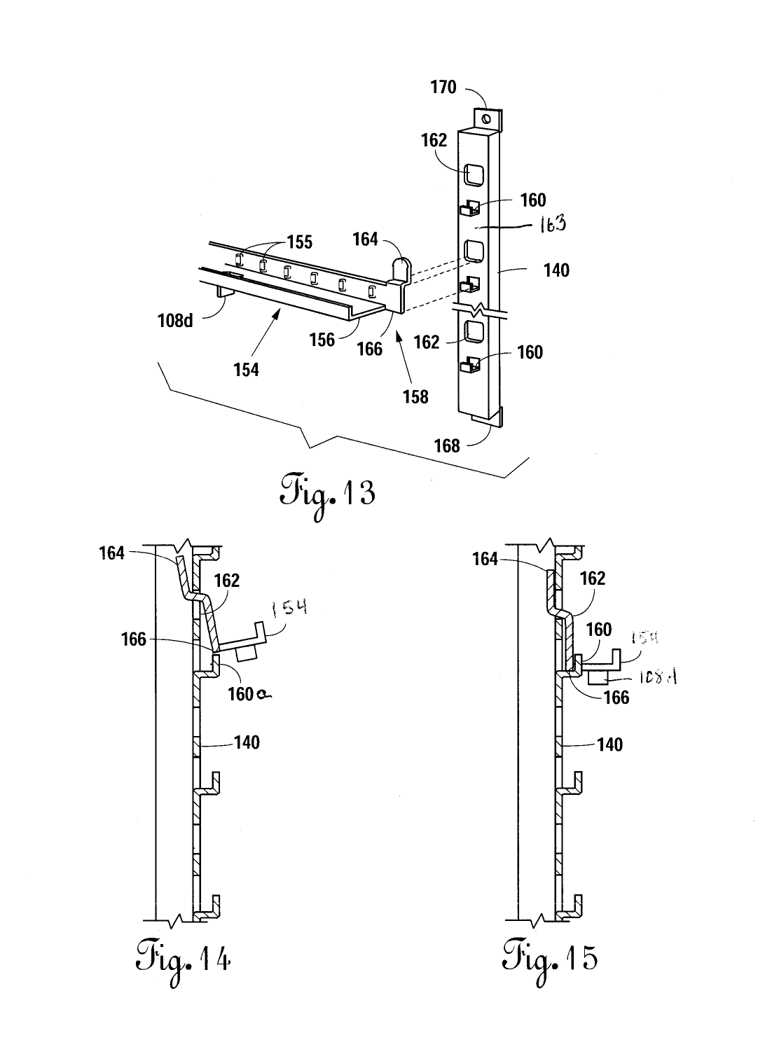

FIG. 13 illustrates that moveable slide rail 152/154 may be provided with a depending stop member 108d and further illustrates the cross-sectional shape of the adjustable slide rails is the same as the earlier embodiments, excepting see one embodiment that used gussets. However, it is also seen that at a front end 156 and a rear end 157 of the rails, a coupling member 158 is seen to extend therefrom, which coupling member removably and toollessly couples and uncouples from cooperating coupling means 160/162 on an inner face 163 of the adjuster bars. More specifically, it is seen that male elements of coupling member 158 engaged with the adjustable slide rails include an offset tongue 164 and a tab engagement member 166 as best seen in FIGS. 13 and 14. Offset tongue 164 is dimensioned to be received within a slot 162 when the rail is tilted at a slight angle and tab engagement member 166 is seen to engage locking support tab 160 when the adjustable slide rail is in the ready position as seen in FIG. 15.

Offset tongue 164 is seen to have an upper lip which extends above the top perimeter of the slot as seen in FIG. 15. This prevents rotation of slide member 154. Coupling of the lower perimeter of tab engagement member 166 with a floor of locking support tab 160 prevents the rail from falling vertically. Moreover, the upstanding portion 160a of locking support tab 160 is seen to prevent the rail from sliding out sideways. Extended coupling members 158 are found at the removed ends of each of the sliding rails and the cooperating pairs of notch-locking support tabs 160 and slots 162 are to be seen spaced apart from their cooperating elements on the opposite side wall such that the one or more moveable adjustable rail pairs 152/154 are the same height above the smoker floor to keep the sliding rails engaged therewith in a horizontal plane.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A food cooking apparatus comprising:
a smoker, the smoker having a smoker cabinet having sidewalls, a closed top wall and a bottom wall, the cabinet walls defining a cabinet interior, and a smoker door moveable between an open position and closed position, the open position allowing access to the cabinet interior, the closed position preventing such access;
a smoker control panel engaging the smoker cabinet, the control panel having a control valve engaged therewith;
a smoker heating element comprising either an electrical element or a gas element, the heating element disposed in the cabinet interior above the bottom wall thereof and engaging the control valve;
a woodchip container;
a cabinet engaging support member adapted to maintain the woodchip container above the smoker heating element;
paired slide rails for adjustably engaging the adjustable base of the smoker cabinet and for slideably supporting the at least one moveable cooling grid;
at least one moveable cooking grid;
adjustment bars with multiple cooking grid positioning elements for engaging the inner walls of the smoker cabinet;
a cabinet smoker damper assembly engaging the smoker cabinet so as to provide gaseous communication between the interior of the smoker cabinet and an exterior thereof;
an oven, the oven having an oven cabinet, the oven cabinet having side walls and a cabinet floor, a top wall, an oven door moveable between an open and a closed position, the open position allowing access to the cabinet interior, the closed position preventing such access, the oven cabinet in gas sealing relation with the smoker cabinet such that almost all or all of the gas in the interior of the smoker and gas in the interior of the oven do not communicate with one another;
an oven control panel having a control valve engaged therewith;
the oven including an oven heating element, the oven heating element comprising either a gas or an electrical element, the overheating element disposed in the oven cabinet interior, the oven heating element engaging the control valve of the oven control panel;
a rack disposed within the oven cabinet;
an oven damper assembly engaging the oven cabinet so as to provide for the communication of gases between the interior of the cabinet and the exterior thereof; and
an energy source for energizing the heating elements of the smoker and the oven.

2. The food cooking apparatus of claim 1, wherein the oven cabinet is disposed over the smoker cabinet.

3. The food cooking apparatus of claim 2, wherein a cabinet smoke damper assembly is engaged with the side walls of the smoker cabinet.

4. The food cooking apparatus of claim 2, wherein the smoker cabinet has a vertical dimension greater than the horizontal dimension thereof.

5. The food cooking apparatus of claim 2, wherein the energy source is electrical.

6. The food cooking apparatus of claim 2, wherein the energy source is gas.

7. The food cooking apparatus of claim 2, further including a movable grid for engaging a water pan and/or the woodchip box.

8. The food cooking apparatus of claim 2, wherein at least one of the smoker door or oven door includes a transparent window.

9. The food cooking apparatus of claim 2, wherein the at least one moveable grid includes a configured member and the paired slide rails include a stop member.

10. The food cooking apparatus of claim 2, further including an oven woodchip box configured to pass through the oven door.

11. The food cooking apparatus of claim 2, wherein the paired slide rails include male members and the adjustment bars include female elements and wherein the male members and female members cooperate to removably couple the slide rails to the adjustment bars.

12. The food cooking apparatus of claim 2, wherein the length and width of the side walls of the oven cabinet are substantially the same as the length and width of the smoker cabinet.

13. The food cooking apparatus of claim 11, further including a multiplicity of removable handles adapted to engage one or more of the walls of the cabinet.

14. The food cooking apparatus of claim 2, wherein the bottom wall of the smoker is flat, and wherein the side walls of the cabinets are flat.

15. The food cooking apparatus of claim 2, wherein the moveable cooking grid engages the paired slide rails such that it is non-tilting.

16. A food cooking apparatus comprising:
a smoker, the smoker having a smoker cabinet having sidewalls and a bottom wall, the cabinet walls defining a cabinet interior, and a smoker door moveable between an open position and closed position, the open position allowing access to the cabinet interior, the closed position preventing such access;
a smoker control panel engaging the smoker cabinet, the control panel having a control valve engaged therewith;
a smoker heating element comprising either an electrical element or a gas element, the heating element disposed in the cabinet interior above the bottom wall thereof and engaging the control valve;
a woodchip container;
a cabinet engaging support member adapted to maintain the woodchip container above the smoker heating element;
multiple cooking grids;
a smoker cabinet damper assembly engaging the smoker cabinet so as to provide gaseous communication between the interior of the smoker cabinet and an exterior thereof;
an oven, the oven having an oven cabinet, the oven cabinet having side walls and a cabinet floor, a top wall, an oven door moveable between an open and a closed position, the open position allowing access to the cabinet interior, the closed position preventing such access, the oven cabinet in gas sealing relation with the smoker cabinet such that gas in the interior of the smoker and gas in the interior of the oven substantially do not communicate with one another;
an oven control panel having a control valve engaged therewith;
the oven including an oven heating element, the oven heating element comprising either a gas or an electrical element, the overheating element disposed in the oven cabinet interior, the oven heating element engaging the control valve of the oven control panel;
a rack disposed within the oven cabinet;
an oven damper assembly engaging the oven cabinet so as to provide for the communication of gases between the interior of the cabinet and the exterior thereof;
an energy source for energizing the heating elements of the smoker and the oven;
adjuster bars for engaging the cabinet inner side walls; and
multiple paired slide rails for removably engaging the adjuster bars at one of several vertical locations within the smoker cabinet;
wherein the cooking grids and the paired slide rails include cooperating elements to prevent full grid slide out and grid filling.

17. The food cooking apparatus of claim 16, wherein the energy source is electrical.

18. The food cooking apparatus of claim 16, wherein the energy source is gas.

19. The food cooking apparatus of claim 16, wherein the energy source is a combination of a gas portion for providing heat to one of the cabinets and an electrical portion for providing heat to the other of the cabinets.

20. The food cooking apparatus of claim 16, further including a water pan with drip rails mounted above said water pan.

21. The food cooking apparatus of claim 16, wherein a cooking grid is configured to receive a water pan therein.

22. The food cooking apparatus of claim 16, further including an oven woodchip box configured to pass through the oven door.

23. The food cooking apparatus of claim 21, wherein the cooking grid is further configured to carry the woodchip box below the water pan.

24. The food cooking apparatus of claim 16, wherein the smoker cabinet has a vertical dimension greater than the horizontal dimension thereof and lies below the oven cabinet.
